(19) United States
(12) Patent Application Publication
(10) Pub. No.: US 2016/0125472 A1
(43) Pub. Date: May 5, 2016

(54) GESTURE BASED ADVERTISEMENT PROFILES FOR USERS

(71) Applicant: THOMSON LICENSING, Issy les Moulineaux (FR)

(72) Inventors: Peter LEE, Calabasas Park, CA (US); Ashwin KASHYAP, Mountain View, CA (US)

(73) Assignee: Thomson Licensing

(21) Appl. No.: 14/891,606

(22) PCT Filed: Jun. 19, 2013
(86) PCT No.: PCT/US2013/046553

§ 371 Date: Nov. 16, 2015

(51) Int. Cl. G06Q 30/02; G06K 9/00; H04N 5/225; G06N 99/00; G06F 3/01

(52) U.S. Cl. CPC G06Q 30/0269; G06N 99/005; G06F 3/017; H04N 5/225; G06K 9/00885

(57) ABSTRACT

The present principles are directed to gesture based advertisement profiles for users. A system includes an advertisement reaction gesture capture device (230) for capturing an advertisement reaction gesture performed by a user responsive to a presentation of a currently presented advertisement. The system further includes a memory device (122) for storing the advertisement reaction gesture.

### TECHNICAL FIELD

The present principles relate generally to advertising and, more particularly, to gesture based advertisement profiles for users.

### BACKGROUND

In recent times, there has been a major push to target advertisements to users instead of the current one-size-fits-all approach. Most current systems personalize advertisements based on the user's interests that include programs watched, zip code, whether the user is male or female, income and other such factors. However, in spite of creating such detailed user profiles, it might still not be possible to discern the effectiveness of an advertisement and its relevance to the user. This is true as many of the correlation assumptions that current systems make about user's interests might not translate to preferences while watching advertisements. Moreover, it is not possible to capture all factors of the user in order to create a user profile.

### SUMMARY

These and other drawbacks and disadvantages of the prior art are addressed by the present principles, which are directed to gesture based advertisement profiles for users.

According to an aspect of the present principles, there is provided a system. The system includes an advertisement reaction gesture capture device for capturing an advertisement reaction gesture performed by a user responsive to a presentation of a currently presented advertisement. The system further includes a memory device for storing the advertisement reaction gesture.

According to another aspect of the present principles, there is provided a method. The method includes capturing an advertisement reaction gesture performed by a user responsive to a presentation of a currently presented advertisement. The method further includes storing the advertisement reaction gesture in a memory device.

According to yet another aspect of the present principles, there is provided a non-transitory storage media having computer readable programming code stored thereon for performing a method. The method includes capturing an advertisement reaction gesture performed by a user responsive to a presentation of a currently presented advertisement. The method further includes storing the advertisement reaction gesture.

According to still another aspect of the present principles, there is provided a system. The system includes a gesture based advertisement classification device for at least one of creating and training an advertisement classification model for a user responsive to one or more advertisement reaction gestures performed by the user that respectively relate to one or more advertisements presented to the user and metadata corresponding to the one or more advertisements, and for creating a gesture based advertisement profile for the user responsive to the advertisement classification model for the user. The system further includes a memory device for storing the gesture based advertisement profile for the user. The gesture based advertisement classification device determines whether or not to show a new advertisement to the user responsive to the gesture based advertisement profile for the user.

According to a further aspect of the present principles, there is provided a method. The method includes at least one of creating and training an advertisement classification model for a user responsive to one or more advertisement reaction gestures performed by the user that respectively relate to one or more advertisements presented to the user and metadata corresponding to the one or more advertisements. The method further includes creating a gesture based advertisement profile for the user responsive to the advertisement classification model for the user. The method also includes storing the gesture based advertisement profile for the user. The method additionally includes determining whether or not to show a new advertisement to the user responsive to the gesture based advertisement profile for the user.

According to a still further aspect of the present principles, there is provided a non-transitory storage media having computer readable programming code stored thereon for performing a method. The method includes at least one of creating and training an advertisement classification model for a user responsive to one or more advertisement reaction gestures performed by the user that respectively relate to one or more advertisements presented to the user and metadata corresponding to the one or more advertisements. The method further includes creating a gesture based advertisement profile for the user responsive to the advertisement classification model for the user. The method also includes storing the gesture based advertisement profile for the user. The method additionally includes determining whether or not to show a new advertisement to the user responsive to the gesture based advertisement profile for the user.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 shows an exemplary processing system 100 to which the present principles can be applied, in accordance with an embodiment of the present principles;

FIG. 2 shows an exemplary system 200 for gesture based advertisement profiling, in accordance with an embodiment of the present principles;

FIG. 3 shows a method 300 for gesture based advertisement profile generation for users, in accordance with an embodiment of the present principles; and

FIG. 4 shows another method 400 for gesture based advertisement profile generation for users, in accordance with an embodiment of the present principles.

### DETAILED DESCRIPTION

The present principles are directed to gesture based advertisement profiles for users.

Gesture based interfaces have become popular and promise better interaction paradigms for users consuming media content such as television shows. It is believed that gesture based interfaces can revolutionize the way users interact with televisions as these interfaces are very simple to use just like the traditional remote control, but they also allow users to express and convey an arbitrary number of commands to the media system.

In an embodiment of the present principles, the user's engagement when the user is watching an advertisement is used to create and/or modify an advertisement profile for the user. In an embodiment, methods and systems are provided to create advertisement profiles for users based on the feedback of users while watching advertisements within television shows or other video multimedia. While one or more embodiments are described herein with respect to a user watching advertisements on a television, it is to be appreciated that the present principles are not limited to applications involving a television and, thus, may involve any multimedia presentation device. These and other variations of the present principles are readily contemplated by one of ordinary skill in the art, given the teachings of the present principles provided herein.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “NB”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

As noted above, the present principles are directed to gesture based advertisement profiles for users.

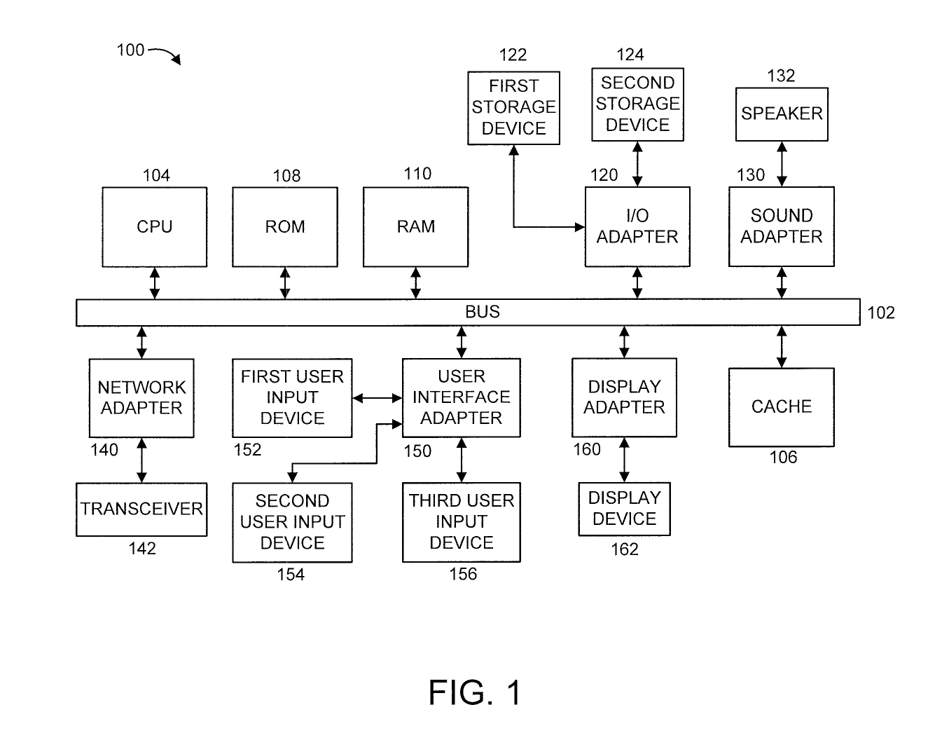

FIG. 1 shows an exemplary processing system 100 to which the present principles may be applied, in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 104.

A first storage device 122 and a second storage device 124 are operatively coupled to system bus 104 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operative coupled to system bus 104 by the sound adapter 130.

A transceiver 142 is operatively coupled to system bus 104 by network adapter 140.

A first user input device 152, a second user input device 154, and a third user input device 156 are operatively coupled to system bus 104 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152 and 154 can be the same type of user input device or different types of user input devices. The user input devices 152 and 154 are used to input and output information to and from system 100.

A display device 162 is operatively coupled to system bus 104 by display adapter 160.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

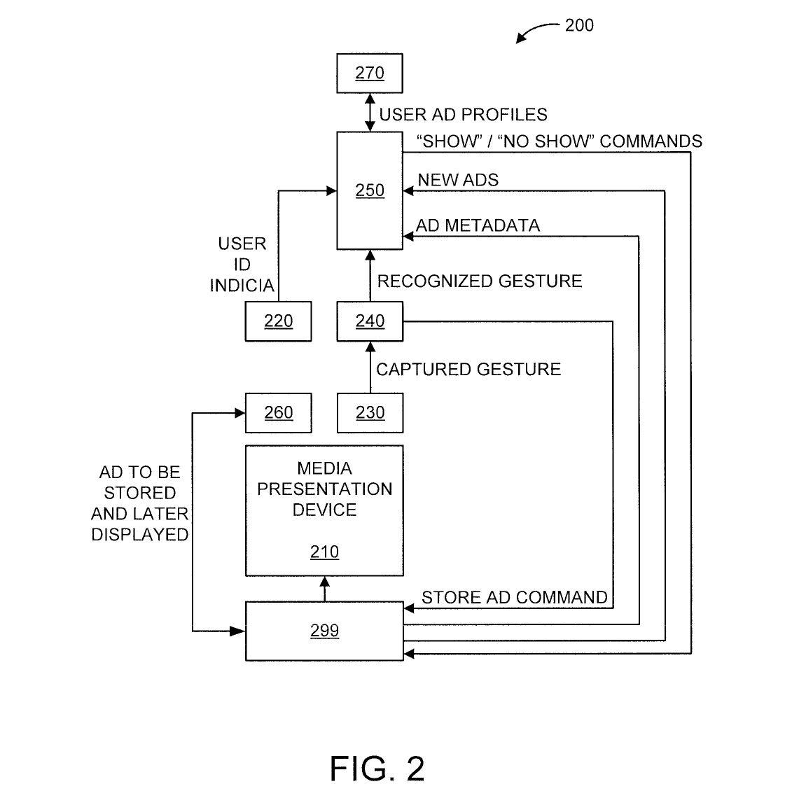

Moreover, it is to be appreciated that system 200 described below with respect to FIG. 2 is a system for implementing respective embodiments of the present principles. Part or all of processing system 100 may be implemented in one or more of the elements of system 200.

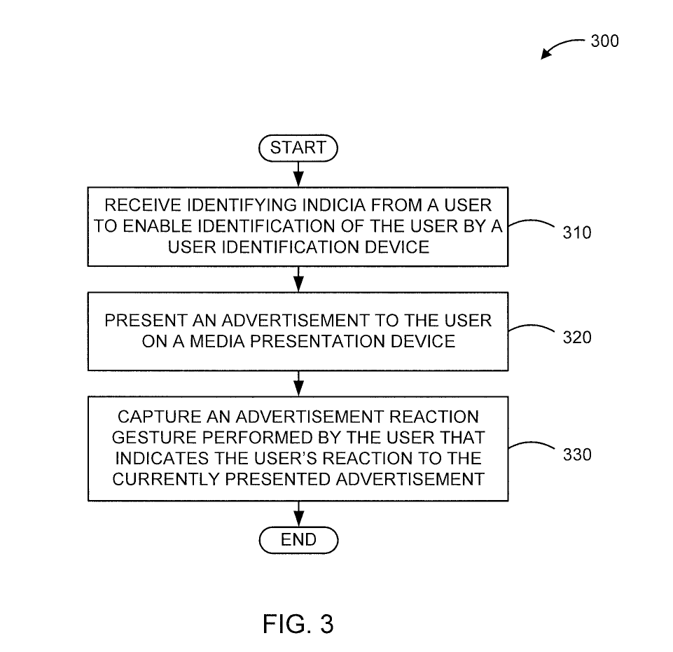

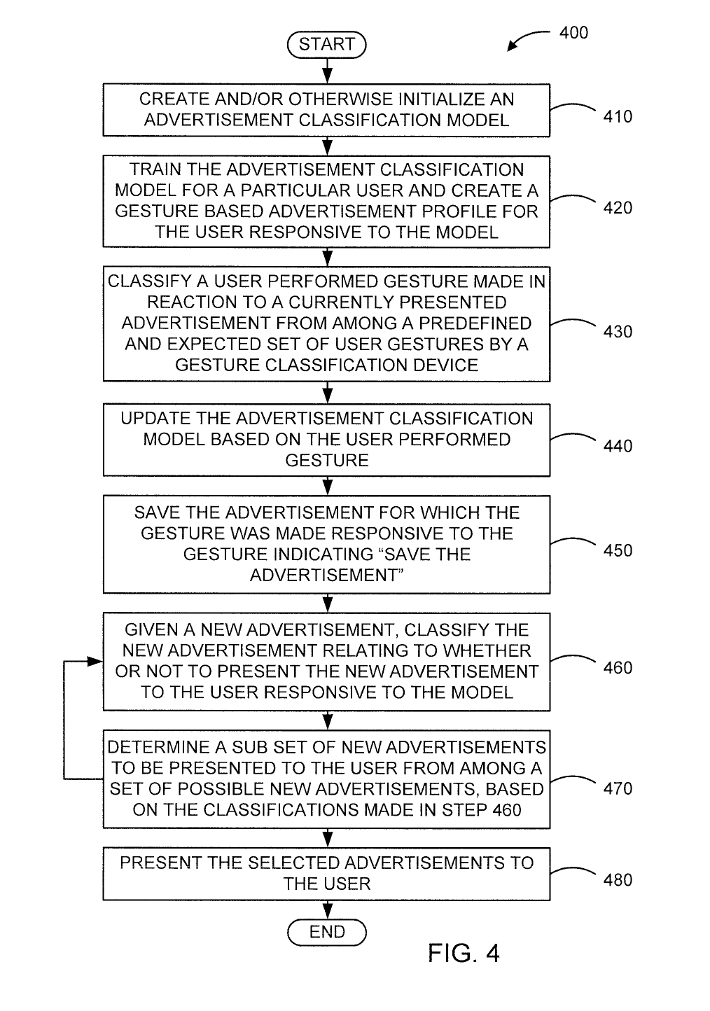

Further, it is to be appreciated that processing system 100 may perform at least part of the method described herein including, for example, at least part of method 300 of FIG. 3 and/or at least part of method 400 of FIG. 4. Similarly, part or all of system 200 may be used to perform at least part of method 300 of FIG. 3 and/or at least part of method 400 of FIG. 4.

FIG. 2 shows an exemplary system 200 for gesture based advertisement profiling, in accordance with an embodiment of the present principles. The system 200 includes a media presentation device 210, a user identification device 220, advertisement reaction gesture capture device (hereinafter “gesture capture device” in short) 230, a gesture recognition device 240, a gesture based advertisement classification device (hereinafter “advertisement classification device” in short) 250, an advertisement storage device 260, and an advertisement user profile storage device 270. While described initially with respect to FIG. 2, the elements of system 200 are also further described in detail herein below.

The media presentation device 210 is used to display advertisements to a user. In an embodiment, the media presentation device is a multimedia presentation device. The media presentation device 210 can be, for example, but is not limited to, a television, a computer, a laptop, a tablet, a mobile phone, a personal digital assistant, an e-book reader, and so forth.

The user identification device 220 is used to identify a particular user, so that a generated advertisement user profile can be created, stored, and/or retrieved for that particular user. The user identification device 220 can be any device capable of identifying the user. In an embodiment, a common remote control can be used, where functionality is added to allow for user identification. In an embodiment, a microphone can be used to allow for user identification. In such a case, the user identification device may incorporate speech recognition and/or speaker recognition. In an embodiment, an image capture device can be used to identify a user. The preceding examples of user identification are merely illustrative and, thus, other ways to identify a user can also be used in accordance with the present principles, while maintaining the spirit of the present principles.

In an embodiment, the user identification device 220 stores a set of identifying indicia for one or more users. In an embodiment, the user identification device 220 stores images (e.g., a set of user images, a set of unique gestures in the case of user identification based on a unique gesture, and so forth) and/or other user identifying indicia (e.g., a set of user names in the case of manual input of user names via a remote control device and/or in the case of speech recognition, a set of particular speaker features in the case of speaker recognition, and so forth) for use in identifying a particular user. Mappings, pattern matching and/or other techniques can be utilized by the user identification device 220 to identify a user.

The gesture capture device 230 can be, and/or otherwise include at least one of an image capture device, a motion sensor input device having image capture capabilities, an accelerator-based device, and so forth. Basically, any device that is capable of capturing a gesture can be used in accordance with the teachings of the present principles.

The gesture classification device 240 classifies gestures captured by the gesture capture device 230. Some exemplary types of gestures are mentioned herein below. Pattern matching and/or other techniques can be used to recognize and/or otherwise classify gestures. For example, multiple patterns can be stored in the gesture classification device 240 and compared to an output provided from the gesture capture device 230 in order to recognize and classify gestures.

The advertisement classification device 250 generates, trains, and updates an advertisement classification model(s) that is used to classify new advertisements. For example, the classification can be binary or non-binary. In an embodiment, binary classification is used, wherein the two options are “show” and “no-show”. The advertisement classification device 250 also generates respective advertisement profiles for users responsive to the model(s).

In an embodiment, a separate advertisement classification model is created for each user. In an embodiment, a user profile comprises a model for that user and indicia identifying that particular user. Alternatively, a single model can be used, but with each user's gestures considered by the model in order to create a user specific advertisement profile for each user. In an embodiment, a user profile comprises user specific information relating to a user's gestures with respect to certain advertisement metadata and indicia identifying that particular user. These and other variations are readily contemplated by one of ordinary skill in the art, given the teachings of the present principles provided herein.

In an embodiment, gestures, indicative of a user's reaction to advertisements presented to the user, are used to train the advertisement classification model. Moreover, in an embodiment, advertisement metadata is used to train the advertisement classification model. Of course, other information can also be used as readily contemplated by one of ordinary skill in the art, given the teachings of the present principles provided herein. The training process can be performed up until a certain time period (training phase), performed at certain frequency intervals (e.g., irrespective of an initial training phase) to update the classification model or performed continually in order to continually optimize the model and resultant classifications provided thereby.

In an embodiment, the advertisement classification device 250 can perform classification using machine learning techniques. In an embodiment, Support Vector Machines (SVMs) are used. Of course, other machine learning techniques can also be used, in place of, or in addition to, the use of SVMs. Moreover, other techniques such as non-machine learning techniques can also be used. These and other variations of the present principles are readily contemplated by one of ordinary skill in the art given the teachings of the present principles provided herein.

The advertisement storage device 260 stores advertisement such as, for example, advertisements flagged for saving by a user. The advertisement storage device 260 can be embodied, for example, at the user end (e.g., in an end device such as, but not limited to, a set top box) and/or at the head end (e.g., in a head end device such as, but not limited to, an advertisement server), and/or in an intermediate device with respect to the user end and the head end.

The advertisement user profile storage device 270 stores advertisement profiles for users.

While not necessarily part of system 200, a set top box 299 or other device can be used to provide selected advertisements to the media presentation device 210, responsive to the classification of advertisements by the model. Thus, while the media presentation device 210 and the set top box 299 are described with respect to system 200, in an embodiment, they may simply be external elements with respect to system 200, to which system 200 interfaces for the purposes of the present principles.

In an embodiment, the functionalities described herein with respect to the user identification device 220 and the gesture capture device 230 can be performed by a single device including, but not limited to, an image capture device. In embodiment, the functionalities of the user identification device 220, the gesture capture device 230, and the gesture recognition device 240 can be performed by a single device. In an embodiment, the functionalities of the advertisement classification device 250 and the advertisement user profile storage device 270 can be performed by a single device. In an embodiment, the functionalities of the advertisement storage device 260 can be incorporated into the set top box 299. Further, in an embodiment, the functionalities of all or a subset of the elements of system 200 can be incorporated into the set top box 299. Moreover, in an embodiment, the functionalities of all or a subset of the elements of system 200 can be incorporated into the media presentation device 210. Additionally, we note that cooperation between elements of system 200 can be based on timestamps and/or other synchronizing information. These and other variations of system 200 are readily contemplated by one of ordinary skill in the art, given the teachings of the present principles provided herein.

FIG. 3 shows a method 300 for gesture based advertisement profile generation for users, in accordance with an embodiment of the present principles. The method 300 is primarily directed to monitoring actions performed by a user with respect to the present principles.

At step 310, identifying indicia is received from a user to enable identification of the user by a user identification device (e.g., user identification device 210 of FIG. 2). The user can be identified, for example, from among a set of possible users. The set of possible users can be a family, a workgroup, and so forth, as readily contemplated by one of ordinary skill in the art, given the teachings of the present principles provided herein. The identifying indicia can involve the user simply presenting himself or herself before an image capture device, by holding up a number of fingers representing that user from among a set of users (or performing some other unique gesture, for example, pre-assigned to that user), or by providing some other identifying indicia, for example, through a remote control, a microphone (by speaking their name (speech recognition) or simply speaking (speaker recognition)), or other user interface.

At step 320, an advertisement is presented to the user on a media presentation device (e.g., media presentation device 210 of FIG. 2).

At step 330, an advertisement reaction gesture (hereinafter “gesture) performed by the user is captured by a gesture capture device (e.g., gesture capture device 230 of FIG. 2) that indicates the user's reaction to the currently presented advertisement.

FIG. 4 shows another method 400 for gesture based advertisement profile generation for users, in accordance with an embodiment of the present principles. The method 400 is primarily directed to the processing of actions performed by a user and an advertisement classification model created and trained for the user.

At step 410, an advertisement classification model is created and/or otherwise initialized by an advertisement classification device (e.g., the advertisement classification device 250 of FIG. 2).

At step 420, the advertisement classification model is trained by the advertisement classification device for a particular user (hereinafter “the user”), and a gesture based advertisement profile is created for the use responsive to the model.

The advertisement classification model can be created and/or otherwise trained based on prior user gestures corresponding to previously displayed advertisements, advertisement metadata, and so forth. In an embodiment, the prior gestures can be provided during a training phase.

At step 430, a user performed gesture made in reaction to a currently presented advertisement (such as that performed in step 330 of method 300) is classified and/or otherwise mapped to a particular user gesture from among a predefined and expected set of user gestures by a gesture classification device (e.g., the gesture classification device 240 of FIG. 2).

At step 440, the advertisement classification model is updated based on the user performed gesture. It is to be appreciated that in an embodiment steps 430 and 440 can be part of step 420. Thus, while shown as separate steps, the steps of training and updating the advertisement classification model can simply and interchangeably be referred to herein as training.

At step 450, the advertisement for which the gesture was made by the user is saved, responsive to the gesture indicating “save the advertisement”.

At step 460, given a new advertisement (e.g., one not yet presented to the user), a classification is made for the advertisement relating to whether or not to present the advertisement to the user responsive to the advertisement classification model. For example, a flag, or bit, or syntax element, or other indicator can be set to either indicate “show” or “no show” with respect to the advertisement and the user. In an embodiment, this information is provided to a set top box. In another embodiment, this information can be provided to the head end or an intermediate device.

At step 470, the method returns to step 460 to determine a subset of advertisements to be presented to the user from among a set of possible advertisement that can be presented to the user, based on the classifications made in step 460.

At step 480, the selected advertisements are presented to the user, for example, during one or more advertisement time slots.

In an embodiment, we infer the user's engagement while the user is watching an advertisement based on the gesture(s) made the user. These gestures can be identified using image capture devices (including, but not limited to cameras, camcorders, webcams, and so forth.), motion sensing devices (e.g., accelerometer-based devices (including, but not limited to, the WHO remote, and so forth)), and motion sensing devices having image capture capabilities (including, but not limited to, KINECT®, MOVE®, etc.). The preceding types of devices are merely illustrative and not exhaustive and, thus, given the teachings of the present principles provided herein, one of ordinary skill in the art will contemplate these and other devices to which the present principles can be applied.

For the sake of illustration, the following are a list of possible gestures that can be used in accordance with the teachings of the present principles:
Push action: indicates the user does not like the advertisement. Assign a rating of 1.
No action: indicates the user is neutral with respect to the advertisement. Assign a rating of 2.
Pull action: indicates the user likes the advertisement. Assign a rating of 3.
Raise hand: indicates to flag the advertisement for more detailed information. Assign a rating of 4.
Hand in pocket action: indicates to save the advertisement for later retrieval. Assign a rating of 5.
   However, it is to be appreciated that other gestures can also be used in accordance with the present principles, while maintaining the spirit of the present principles. For example, a “thumb up” gesture can be used to indicate that an advertisement is liked, while a “thumb down” gesture can be used to indicate that an advertisement is not liked. Similarly, it is to be appreciated that other ratings and/or other rating systems can also be used in accordance with the present principles, while maintaining the spirit of the present principles.

In an embodiment, a classifier is built that is trained using these (and/or other) gestures. Once enough training data has been collected, a classification model is created. In an embodiment, the classification model can be created using Support Vector Machines (SVM). Of course, other approaches to creating a classification model can also be used, while maintaining the spirit of the present principles. The classification model is later used to classify new advertisements to either be shown or not shown. In technical terms relating to the aforementioned embodiment, this is a binary classification system that trains on various features of the advertisement such as advertisement metadata as well as user gestures. Of course, the present principles are not limited to binary classification and, thus, non-binary classification can also be used in accordance with the present principles, while maintaining the spirit of the present principles.

A description will now be given regarding advertisement metadata, in accordance with an embodiment of the present principles.

In order to train a model, each advertisement needs to have metadata so that the classification algorithm can create and train a model based on certain features of the advertisement. We presume that these features can either be created manually while the advertisement was created or could be extracted automatically using suitable feature extraction algorithms. In an embodiment, we have identified the following features to be features of interest for an advertisement and the corresponding values these features can have:
Category: sports, auto, pharmaceutical, travel, food, restaurant, beverage, health, shopping
Age: 10s, 20s, 30s . . . 90s
Format: 30 sec, 15 sec, overlay
Sound: music, voice
Style: action, comedy, information, romance
   Of course, it is to be appreciated that the preceding features are merely illustrative and, thus, other features as well as other values therefor can be also be used in accordance with the present principles, while maintaining the spirit of the present principles.

It is presumed that the advertisement will be suitably stored. In an embodiment, the advertisement can be stored in the end device such as a set top box and/or in the head end such as in an advertisement server. The function of the set top box is to create a user advertisement model based on previous watching and gestures as well as to select which new advertisement will be shown given a list of relevant advertisements. The advertisements can be scheduled in the program using existing schemes. For example, targeted advertisements can be either statically scheduled or the program can be segmented according to a user profile so as to show advertisements with a maximum impact on the user. Of course, other schemes can also be used in accordance with the present principles.

In an embodiment, for each advertisement segment, we presume that there is time for “n” advertisements to be shown from among a total of “N” available advertisements. Thus, the “n” advertisements can be selected from among the “N” advertisements. We presume that this has already been done suitably, for example, using manual and/or automated methods. In an embodiment, we classify these “N” advertisements as either “show” or “no-show”.

In addition to the advertisement creator metadata, each advertisement will be augmented with the features corresponding to one or more user actions. The user action feature can have the following values:
User_action: (no_like, neutral, like, info, save_share).
   These values correspond to user gestures for each advertisement. Of course, other values can also be used, while maintaining the spirit of the present principles.

In an embodiment, in order to create a training set, we formulate the problem as binary classification. The advertisement is either not-watched or watched (represented by 0 or 1, respectively). Once the training is complete, the goal of the binary classifier is to predict, given a new advertisement, whether or not the user will watch the new advertisement. One issue that presents itself here is that while the advertisement can be watched and enjoyed repeatedly, at the same time, the user would also like to discover new advertisements. In order to address this issue, we define a parameter alpha (0≦alpha≦1). If alpha=0, then only new advertisements will be suggested to the user. If alpha=1, then only already watched advertisements will be shown. This parameter can be tuned to each user, for example, based on preferences and/or as suggested by the service provider. Advertisements can then be chosen based on, for example, a predetermined value of alpha. Typically, alpha=0.5. The parameter alpha is interchangeably referred to herein as a mixing parameter, since it governs to some extent the mixing of never seen advertisements with previously seen advertisements.

Furthermore, in an embodiment, we can filter out older advertisements. The filtering of older advertisement can be based on the requirements of, for example, the content owner, the advertiser, and/or the service provider. Of course, other considerations can also be used in the process of filtering. In an embodiment, filtering is done prior to the training phase in order to preserve the accuracy of the classifier.

To summarize with respect to an illustrative embodiment, the training set (for advertisements already watched) is as follows:
0: <f1>, <f2>, <f3> . . .
1: <f1>, <f2>, <f3> . . .
   where <f?> is a feature (category, age, format, user action, and so forth). The value of 0 or 1 is based on whether or not the user watched the advertisement. Hence, classification is based on the features, as follows:

### Classification:

?: <f1><f2><f3> . . .
   Thus, given a new advertisement, we need to decide whether or not to show the advertisement.

In an embodiment, the present principles can consider additional information (that is, in addition to gestures) in order to make the decision of whether or not an advertisement was watched. Frequently, users will not provide any gesture feedback because they might be away from the video terminal or they might be interacting with a second screen device. In such circumstances, in an embodiment, we will ignore the neutral rating and consider that the advertisement was not watched and, thus, will not include the advertisement in the training set. This event can be detected with the help of a camera or using other suitable methods.

A description of the classification algorithm will now be given, in accordance with an embodiment of the present principles.

We believe this classification problem is non-linear in nature. Hence, we will not be able to separate out the 0/1 points easily with a hyperplane. In order to overcome this, in an embodiment, we will employ a margin-based classifier. Of course, other types of classifiers can also be used. In an embodiment, we choose Support Vector Machines (SVMs) for the margin-based classifier. Using non-linear kernels, it will be possible to implicitly project points to a higher dimension space and separate the 0/1 point in this higher dimension space. This is a known technique and is frequently referred to as the kernel trick. There are various software implementations for SVM. Presuming a limited number of features and a relatively small size of the corresponding data set, we will not have issues with speed and memory. It should also be noted that this computation can either be performed on a suitably equipped set top box or, if need be, it can be offloaded to a larger machine deployed in the head-end or a server farm/cloud.

We employ the following conventions:
n=the number of advertisements to be shown in the advertisement slot. This is typically specified by the content owner.
N=the total number of advertisements available for that slot. These advertisements are provided by the advertising network.
N′=number of advertisements (out of N) classified as “show”.
   Ideally, n′=n. However, the cases can occur that n′=0 or n′=N. In such cases, we need to determine which advertisement will be shown.

Many implementations of a support vector machine (such as LIBSVM) include a method to estimate the class membership probabilities. This is a number between 0 and 1 which denotes the confidence of the classification by the SVM. In an embodiment, we shall use the class membership probabilities in the case when we have an insufficient number of advertisements to be shown or if there are too many classified as “show”. These probabilities are sorted in decreasing order and the top n probabilities will be considered and the corresponding advertisements will be shown to the user.

In order to keep computation to a minimum, in an embodiment, we discard all data that was collected more than a few weeks ago. In addition to improving the computation, it will also let users discover new advertisements and prevent advertisement fatigue. Of course, other time periods can also be used.

We maintain a list of advertisements that were watched along with their timestamps (recall that some advertisements will not be considered to be watched even if there was a neutral gesture). When giving recommendations on which advertisement to show, the algorithm should satisfy the following:
Choose among the best possible advertisements based on classification and class probabilities.
Prevent advertisement fatigue: do not repeat recently watched advertisements (also referred to herein as an “advertisement fatigue constraint”).
Show a combination of never watched and some watched advertisements (e.g., according to the aforementioned parameter alpha).

A description of some other considerations that can be utilized will now be given in accordance with an embodiment of the present principles.

SVMs are very accurate but are offline in nature. SVMs have two distinct phases, namely a training phase and a test phase. In general, this will not be an issue since advertisements are shown once in ten minutes or so and, thus, there will be more than sufficient time to rebuild (update) the model based on any input received in the previous advertisement slot. There are certain situations that this will not provide optimal results such as when the user is channel surfing or when the user is trying to watch two programs and is constantly switching at every advertisement slot in the programs. In these situations, the system might not have the most up to data model to make predictions. However, we do not consider this to be sufficiently problematic to solve.

A description of some exemplary applications to which the present principles can be applied will now be given. Of course, the following is merely illustrative and not exhaustive. As noted above, one such application is providing recommendations of which advertisements to show a particular user. Another such application is measuring advertisement effectiveness. In such an application, the present principles can be used to provide valuable feedback and analytics to advertisers as well as content owners. Using this information, it will be possible for advertisers to adapt their strategy to obtain the most benefit for money spent on advertisements. Given the teachings of the present principles provided herein, one of ordinary skill in the art will contemplate these and various other applications to which the present principles can be applied, while maintaining the spirit of the present principles.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

What is claimed is:

1. A system, comprising:
a gesture capture device that captures an advertisement reaction gesture performed by a user, responsive to a presentation of a presented advertisement; and
a memory device that stores the advertisement reaction gesture.

2. The system of claim 1, further comprising a user identification device that identifies the user, responsive to user identifying indicia provided by the user.

3. The system of claim 2, wherein the user identifying indicia comprises speech, and the user identification device comprises at least one of a speech recognition system and a speaker recognition system to identify the user from the speech.

4. The system of claim 2, wherein the user identification device comprises an image capture device that identifies the user based on a comparison of a user identifying gesture made by the user to a database of user identifying gestures, each of the user identifying gestures being unique to a respective one of a plurality of users.

5. The system of claim 2, wherein the user identification device comprises an image capture device that identifies the user based on a comparison of a captured image of the user to a database of user images.

6. The system of claim 2, wherein the user identification device and the gesture capture device are comprised in a single device comprising an image capture device.

7. The system of claim 1, wherein the gesture capture device comprises at least one of an image capture device, a motion sensing device, and a motion sensing device having image capture capabilities.

8. A method, comprising:
capturing an advertisement reaction gesture performed by a user, responsive to a of presented advertisement; and
storing the advertisement reaction gesture in a memory device.

9. The method of claim 8, further comprising identifying the user, responsive to user identifying indicia provided by the user.

10. The method of claim 9, wherein the user identifying indicia comprises speech, and said identifying step comprises using at least one of speech recognition and speaker recognition to identify the user from the speech.

11. The method of claim 9, wherein said identifying step comprises comparing a user identifying gesture made by the user to a database of user identifying gestures, each of the user identifying gestures being unique to a respective one of a plurality of users.

12. The method of claim 9, wherein said identifying step comprises comparing a captured image of the user to a database of user images.

13. The method of claim 9, wherein said identifying and capturing steps are performed by a single device comprising an image capture device.

14. A non-transitory storage media having computer readable programming code stored thereon to perform a method, the method comprising:
capturing an advertisement reaction gesture performed by a user, responsive to a presented advertisement; and
storing the advertisement reaction gesture.

15. A system, comprising:
a gesture classification device that performs at least one of creating and training an advertisement classification model for a user, responsive to one or more advertisement reaction gestures performed by the user that respectively relate to one or more advertisements presented to the user and metadata corresponding to the one or more advertisements, and to create a gesture based advertisement profile corresponding to the user, responsive to the advertisement classification model corresponding to the user;
a memory device that stores the gesture based advertisement profile corresponding to the user; and
wherein the gesture classification device determines whether or not to show a new advertisement to the user responsive to the gesture based advertisement profile corresponding to the user.

16. The system of claim 15, wherein the new advertisement is stored in the memory device which is later retrieved and presented to the user, responsive to a particular gesture performed by the user that indicates the user intends to have the new advertisement to be saved.

17. The system of claim 15, wherein the gesture based advertisement classification device selects a subset of new advertisements to show to the user during a given advertisement time slot from among a set of new advertisements responsive to the gesture based advertisement profile for corresponding to the user.

18. The system of claim 17, wherein the subset of new advertisements is selected further responsive an advertisement fatigue constraint and a mixing constraint, the mixing constraint to show a combination of never watched and previously watched advertisements based on a mixing parameter.

19. The system of claim 15, wherein the advertisement classification model is at least one of created and trained by applying a machine learning technique to features of the one or more advertisements and features of the one or more advertisement reaction gestures relating thereto.

20. The system of claim 19, wherein the machine learning technique comprises applying a margin based classifier to the features of the one or more advertisements and the features of the one or more advertisement reaction gestures relating thereto.

21. The system of claim 19, wherein the machine learning technique comprises applying a support vector machine to the features of the one or more advertisements and the features of the one or more advertisement reaction gestures relating thereto.

22. A method, comprising:
at least one of creating and training an advertisement classification model that is responsive to one or more advertisement reaction gestures performed by the user that respectively relate to one or more advertisements presented to the user and metadata corresponding to the one or more advertisements;
creating a gesture based advertisement profile that is responsive to the advertisement classification model corresponding to the user;
storing the gesture based advertisement profile corresponding to the user; and
determining whether or not to show a new advertisement to the user responsive to the gesture based advertisement profile corresponding to the user.

23. The method of claim 22, further comprising saving the new advertisement that is later retrieved and presented to the user, responsive to a particular gesture performed by the user that indicates the user intends that the new advertisement be saved.

24. The method of claim 22, further comprising selecting a subset of new advertisements to show to the user during a given advertisement time slot from among a set of new advertisements responsive to the gesture based advertisement profile corresponding to the user.

25. The method of claim 24, wherein the subset of new advertisements is selected further responsive an advertisement fatigue constraint and a mixing constraint that intends to show a combination of never watched and previously watched advertisements based on a mixing parameter.

26. The method of claim 22, wherein the advertisement classification model is at least one of created and trained by applying a machine learning technique to features of the one or more advertisements and features of the one or more advertisement reaction gestures relating thereto.

27. The method of claim 26, wherein the machine learning technique comprises applying a margin based classifier to the features of the one or more advertisements and the features of the one or more advertisement reaction gestures relating thereto.

28. The method of claim 26, wherein the machine learning technique comprises applying a support vector machine to the features of the one or more advertisements and the features of the one or more advertisement reaction gestures relating thereto.

29. A non-transitory storage media having computer readable programming code stored thereon to perform a method, the method comprising:
at least one of creating and training an advertisement classification model that is responsive to one or more advertisement reaction gestures performed by the user that respectively relate to one or more advertisements presented to the user and metadata corresponding to the one or more advertisements;
creating a gesture based advertisement profile corresponding to that is responsive to the advertisement classification model for the user;
storing the gesture based advertisement profile corresponding to the user; and
determining whether or not to show a new advertisement to the user responsive to the gesture based advertisement profile corresponding to the user.
